(19) United States
(12) Patent Application Publication
(10) Pub. No.: US 2026/0248600 A1
(43) Pub. Date: Aug. 27, 2026

(54) TOOTHBRUSH WITH TONGUE SCRAPPER

(71) Applicant: Duc NGUYEN, San Diego, CA (US)

(72) Inventors: Duc NGUYEN, San Diego, CA (US); Bartek ZALEWSKI, Newmarket (CA); Kyeong Hoon KIM, Toronto (CA)

(21) Appl. No.: 19/551,757

(22) Filed: Feb. 27, 2026

Related U.S. Application Data
(60) Provisional application No. 63/764,119, filed on Feb. 27, 2025.

(51) Int. Cl. A61C 17/00; A46B 15/00

(52) U.S. Cl. CPC A61C 17/00; A46B 15/0081; A46B 2200/1066

(57) ABSTRACT

In an embodiment, a manual toothbrush includes a head, neck, and handle. The head defines a head front surface and a head rear surface, the head front surface having a plurality of bristles extending therefrom. The neck region defines a neck front surface and a neck rear surface. The handle defines a handle front surface and a handle rear surface, the head rear surface, the neck rear surface, and the handle rear surface all generally facing away from the bristles. One of the neck region and the handle defines a recess therein. The toothbrush further includes a tongue scraper, the tongue scraper carried in the recess, the tongue scraper including at least one scraping edge extending within the recess. A first plane co-extends from the head rear surface toothbrush towards an end of the handle. The at least one scraping edge extends toward the first plane and remains therebelow.

### RELATED APPLICATIONS

This application claims domestic priority under 35 U.S.C. § 119(e) to U.S. Provisional Application No. 63/764,119, filed Feb. 27, 2025, the contents of which are hereby incorporated by reference thereto.

### TECHNICAL FIELD

This disclosure is directed generally to dental products. More particularly, the disclosure is directed to a manual toothbrush with a tongue scraper.

### BACKGROUND ART

Toothbrushes are a longstanding staple in modern health to allow people to clean their teeth daily at home to prevent gum disease and other diseases that may arise from the failure to keep one's mouth, specifically gums and teeth, clean. As toothbrushes have evolved, there have been many advancements such as electric toothbrushes, different bristle types, and replacement toothbrush heads amongst others.

Many manual toothbrushes today have a rubber or rubber-like pad on the back side of the head or bristled portion of the toothbrush. The pad has a number of elevated portions that aid in scraping the tongue. Scraping the tongue is an important part of dental hygiene as it can remove bacteria and debris, improve breath freshness, reduce the risk of oral infections, and overall tongue scraping promotes better oral hygiene. The downside of the current tongue scrapers on current manual toothbrushes is that they are relatively flat and do not provide the most efficient tool for tongue scraping.

There are also standalone tongue scrapers that are sold but these do not have the simplicity of being a two-in-one product because the standalone tongue scrapers are separate from a toothbrush and therefore someone is required to use two tools to accomplish brushing one's teeth and scraping their tongue, which is inefficient.

### SUMMARY OF THE INVENTION

In one aspect, an exemplary embodiment of the present disclosure may provide a manual toothbrush that includes a head, a neck, and a handle. The head can define a head front surface and a head rear surface, the head front surface having a plurality of bristles extending therefrom. The neck region can define a neck front surface and a neck rear surface. The handle can define a handle front surface and a handle rear surface, the head rear surface, the neck rear surface, and the handle rear surface all generally facing away from the bristles. One of the neck region and the handle can define a recess therein. The toothbrush can further include a tongue scraper, the tongue scraper carried in the recess, the tongue scraper including at least one scraping edge extending within the recess. A first plane can co-extend from the head rear surface toothbrush towards an end of the handle. The at least one scraping edge can extend toward the first plane and remain therebelow, the tongue scraper thereby configured to not touch an adjoining flat surface when the toothbrush is resting on a back surface of the toothbrush.

In one aspect, an exemplary embodiment of the present disclosure may provide a manual toothbrush comprising: a handle including a front surface and a rear surface, wherein the front surface and the rear surface are opposed to one another and define a thickness of the handle therebetween; a head including a front surface and a rear surface, wherein the front surface has a plurality of bristles extending therefrom; a neck region having a front surface and a rear surface, wherein the neck region is located between the handle and the head of the toothbrush, and the neck region defines a cut out or recess in the neck region; and a tongue scraper including at least one scraping edge that extends through and/or within the cut out, wherein a dimension of the scraping edge is less than a thickness of the toothbrush; wherein the dimension of the scraping edge is less than the depth of the cut out.

In one aspect, an exemplary embodiment of the present disclosure may provide a manual toothbrush including a handle, a head, a neck region, and a tongue scraper. The handle can include a handle front surface and a handle rear surface, wherein the handle front surface and handle rear surface are opposed to one another and define a thickness of the handle therebetween. The head can include a head front surface and a head rear surface, wherein the head front surface has a plurality of bristles extending therefrom. The neck region can define a neck front surface and a neck rear surface, the neck region being located between the handle and the head of the toothbrush. One of the neck region or the handle can define a recess therein. The tongue scraper can be carried in the recess defined in the one of the neck region or the handle, the tongue scraper including at least one scraping edge that extends within the recess and projects away from the recess. A thickness dimension of the scraping edge is less than a thickness of the toothbrush. A first plane can co-extend from the head rear surface of the toothbrush towards an end of the handle. A depth dimension of each scraping edge can be chosen so that the at least one scraping edge extends below the first plane, the tongue scraper thereby configured to not touch an adjoining flat surface when the toothbrush is resting on a back surface of the toothbrush.

In another aspect, an exemplary embodiment of the present disclosure may provide the manual toothbrush with any of various features. The at least one scraping edge can be made of at least one of a plastic material or a hard rubber material. The manual toothbrush can further include a plurality of scraping edges, wherein the scraping edges are made from plastic or rubber. The at least one scraping edge can be made from plastic, and a point of the scraping edge can be made from rubber. The recess of the tongue scraper can be located in the rear surface of the neck region. The recess can be located in the rear surface of the handle. The scraping edge can have a rounded point. The at least one scraping edge lies entirely within the recess. At least a portion of the recess can define a recess exterior surface, wherein the at least one scraping edge at least one of contacts or is connected to the recess exterior surface. The recess exterior surface is comprised of a rubber material. The recess exterior surface can be at least one of carried by or integral with the one of the neck region and the handle in which the recess is formed. The handle, the neck region, and the brush head can each be made of at least one of a hard rubber material or a plastic material. The handle, the neck region, and the brush head can be operatively coupled to one another, in that order.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front isometric view of a manual toothbrush having a tongue scraper.

FIG. 2 is a rear isometric view of the manual toothbrush having a tongue scraper.

FIG. 3 is a first side elevation view of the manual toothbrush having a tongue scraper.

FIG. 4 is a second side elevation view of the manual toothbrush having a tongue scraper.

FIG. 5 is a rear elevation view of the manual toothbrush depicting the lengths of a head of the manual toothbrush and a neck of the manual toothbrush.

FIG. 6 is a top plan view of the manual toothbrush having a tongue scraper.

FIG. 7 is a cross-section view of a scraping edge of the tongue scraper of the manual toothbrush taken along line 7-7 in FIG. 5.

FIG. 8 is a rear perspective view of a second embodiment of the manual toothbrush having a tongue scraper.

FIG. 9 is a side elevation view of the second embodiment of the manual toothbrush having a tongue scraper.

FIG. 10 is a rear elevation view of the second embodiment of the manual toothbrush depicting the lengths of a head of the manual toothbrush and a neck of the manual toothbrush.

FIG. 11 is a cross-section view of a scraping edge of the tongue scraper of the manual toothbrush taken along line 11-11 in FIG. 10.

FIG. 12 is a rear perspective view of a third embodiment of the manual toothbrush having a tongue scraper.

FIG. 13 is a side elevation view of the third embodiment of the manual toothbrush having a tongue scraper.

FIG. 14 is a rear elevation view of the third embodiment of the manual toothbrush having a tongue scraper.

FIG. 15 is a top plan view of the third embodiment of the manual toothbrush having a tongue scraper.

FIG. 16 is a cross-section view of a plurality of scraping edges of the tongue scraper of the manual toothbrush taken along line 16-16 in FIG. 14.

FIG. 17 is a rear perspective view of a fourth embodiment of the manual toothbrush having a tongue scraper.

FIG. 18 is a rear elevation view of the fourth embodiment of the manual toothbrush having a tongue scraper.

FIG. 19 is a cross-section view of a plurality of scraping edges of the tongue scraper of the manual toothbrush taken along line 19-19 in FIG. 18.

FIG. 20 is an operational view of a consumer using the tongue scraper of the manual toothbrush.

Similar numbers refer to similar parts throughout the drawings.

### DETAILED DESCRIPTION

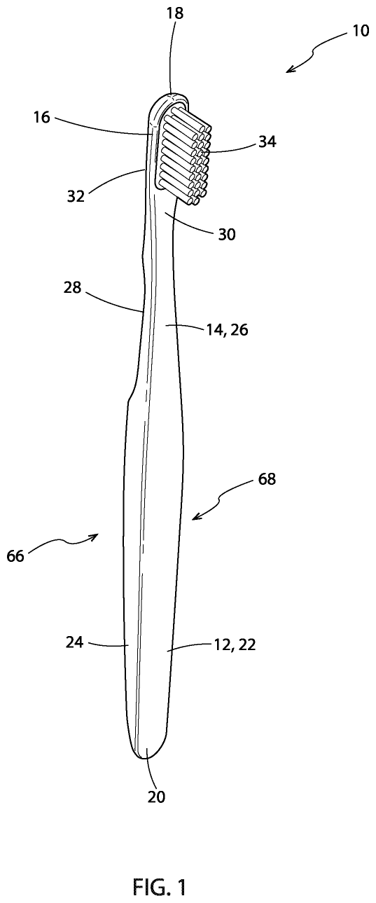

The manual toothbrush with tongue scraper of the present disclosure is depicted throughout FIGS. 1-20. The manual toothbrush is a toothbrush with tongue scraping capabilities because the manual toothbrush may have a plastic and/or rubber scraping edge acting as the tongue scraper. The plastic scraping edge may be provided with a TPU rubber tip as a tongue scraper and/or more than one scraping edge acting as a tongue scraper. TPU rubber stands for thermoplastic polyurethane which combines characteristics of both rubber and plastic. The tongue scraper of the present disclosure may be located in various locations on the toothbrush, and the cutout or recess of a tongue scraper can house the scraping edge of the toothbrush body in a position that ensures the tongue scraper does not contact any surface when the toothbrush is laid flat. The scraping edge of the tongue scraper of the present disclosure allows an effective scraping action, and the configuration of the scraping edge prevents a sharp edge that may unintentionally cut the user. It is to be understood that the terms cutout or recess may be used interchangeably herein with respect to the tongue scraper section of the toothbrush. Further, it is to be understood that the cutout or recess may be formed in the toothbrush by cutting (e.g., material removal), molding, press stamping, or any other process and be within the intended scope of such a formation in the toothbrush.

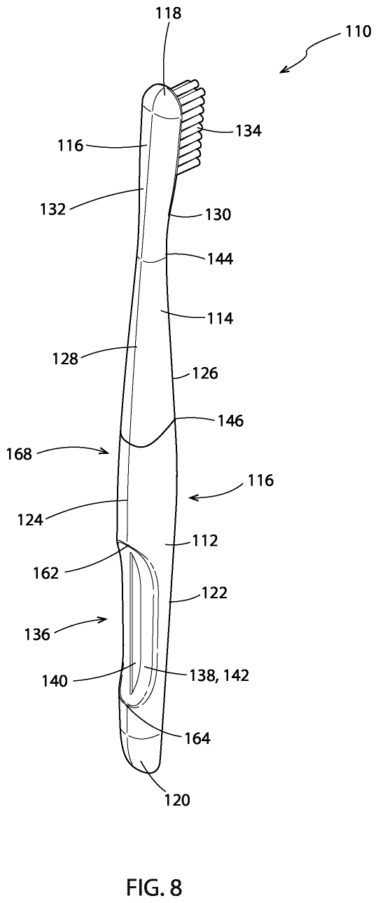

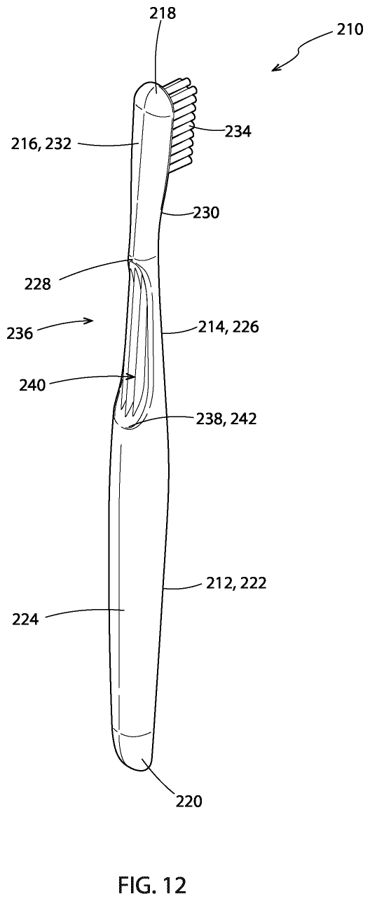

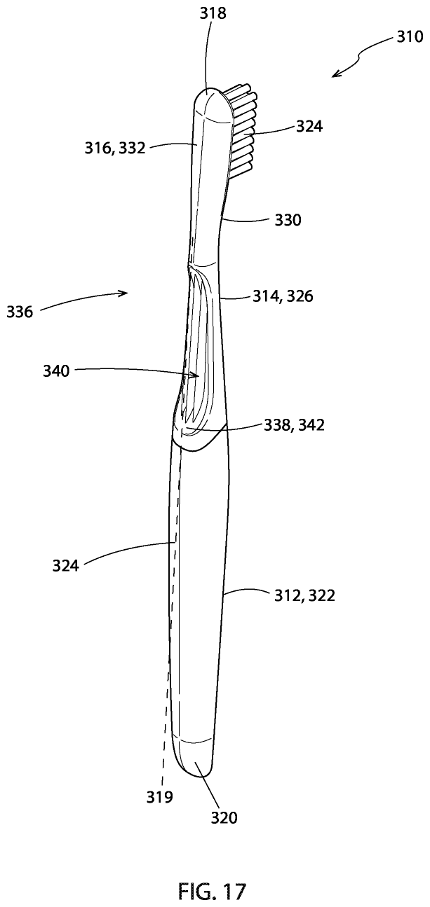

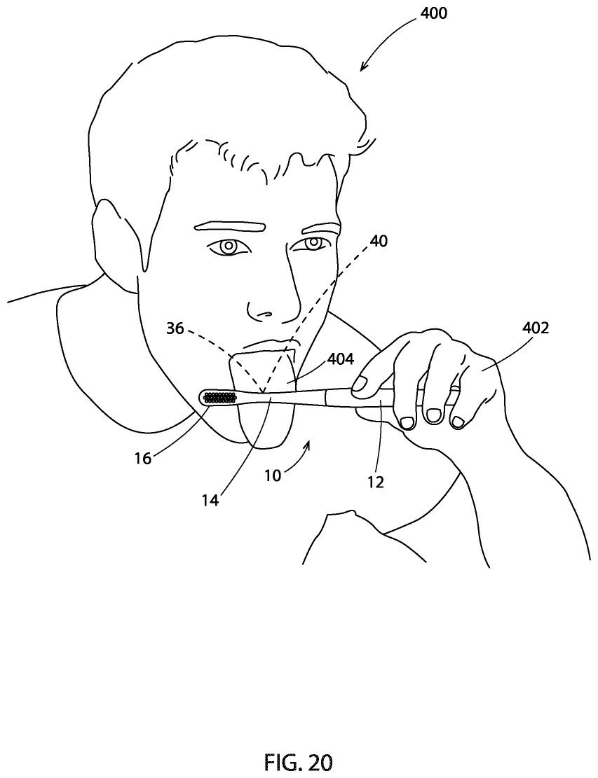

Four embodiments of the present disclosure are described herein. The manual toothbrush shown in FIGS. 1-7 may be shown generally as 10. The manual toothbrush shown in FIG. 8-11 may be shown generally as 110. The manual toothbrush shown in FIGS. 12-16 may be shown generally as 210. The manual toothbrush shown in FIGS. 17-19 may be shown generally as 310. The manual toothbrush shown in FIG. 20 may be any of the manual toothbrushes, namely manual toothbrush 10, 110, 210 or 310.

A first embodiment of the manual toothbrush 10 may include a handle 12, a neck region 14, and a brush head 16. The manual toothbrush 10 may further include a top end 18 and a bottom end 20, wherein the top end 18 is opposed to the bottom end 20. The direction of top and bottom may change during operation and may then be located in a top, bottom, first side, or second side of the manual toothbrush 10. In an embodiment, the top end 18 of the manual toothbrush 10 can incorporate the brush head 16 thereof.

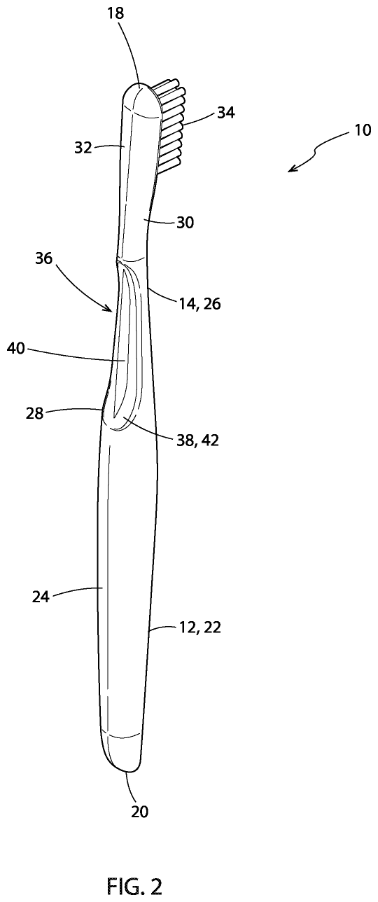

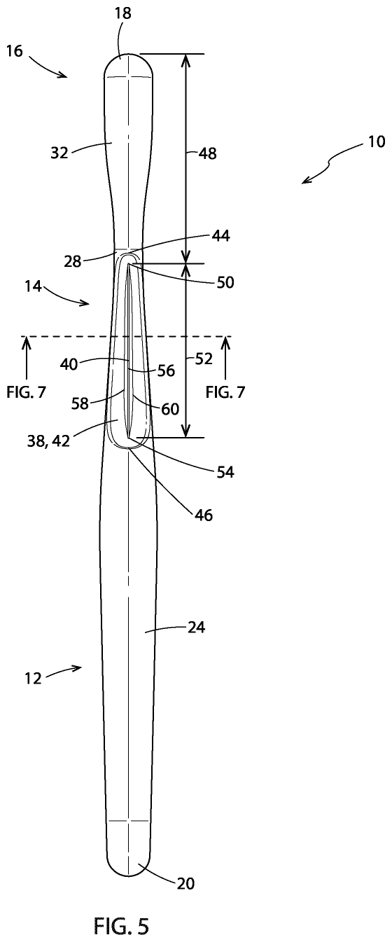

FIG. 1 depicts the handle 12 having a front surface 22 and a rear surface 24 wherein the front surface 22 and the rear surface 24 are integrally connected but opposite each other. The handle 12 may be made from TPU rubber, plastic, or any other material. FIG. 1 further depicts the neck region 14 as having a front surface 26 and a rear surface 26 which will be described in more detail in FIG. 2 and FIG. 5. Front surface 26 of the neck region 14 may be coextensive or continuous with the front surface 22 of the handle 12. Rear surface 28 of the neck region 14 may be coextensive or continuous with the rear surface 24 of the handle 12. As shown in FIG. 1, brush head 16 has a front surface 30 opposite a rear surface 32. Front surface 30 of brush head 16 includes bristles 34 wherein the bristles are fixedly connected to the front surface 30 of the brush head 16 and extend outward therefrom to respective terminal ends and away from the rear surface 32 of brush head 16. In an embodiment, the front surface 30 of the brush head 16 can generally extend on the same side of the manual toothbrush 10 as the front surface 22 of the handle 12. In an embodiment, the rear surface 32 of the brush head 16 can generally extend on the same side of the manual toothbrush 10 as the rear surface 24 of the handle 12 and the rear surface 28 of the neck region 14.

Handle 12, neck region 14, and brush head 16 can collectively define the manual toothbrush 10. The handle 12 can be considered to be the lower portion of the manual toothbrush 10 that may be used to grip the toothbrush 10 by the user. The neck region 14 of the toothbrush is the space between the handle 12 of the toothbrush 10 and the head 16 of the toothbrush 10. In an embodiment, the head 16 is at the top of the neck region 14, opposite the handle 12, and the head 16 contains/carries the bristles 34 which are used to clean the end user's teeth. In an embodiment, the bristles 34 extend directly from the front surface 30 of the head 16.

FIG. 2 depicts the rear of the manual toothbrush 10. Focusing on the neck region 14, tongue scraper 36 is shown. In the depicted embodiment, there is a cut out or recess 38 defined in the neck region 14. In one embodiment, the cut out 38 extends the length of the neck region 14. However, it is possible for the cut out 38 to extend only a portion of the length of the neck region 14. Inside the cut out 38, there is a scraping edge 40. In one embodiment, the scraping edge 40 may be made from plastic or a hard rubber material. The cut out 38 is deep enough to allow the scraping edge 40 to be mostly or entirely within the cut out 38 to prevent the scraping edge 40 from touching a surface if the toothbrush 10 was laid flat on the rear side of the toothbrush. An exterior surface 42 defines a portion of cut out 38, wherein the scraping edge 40 contacts or is connected to the exterior surface 42. In one exemplary embodiment, the exterior surface 42 of the cut out 38 may be made of TPU (thermoplastic polyurethane) rubber or other material similar to the handle 12 of the manual toothbrush 10. In an embodiment, the exterior surface 42 of the cut out 38 may be carried by the neck region 14 or may be integral therewith. The cut out 38 forms an elongated u-shape or a concave wall when looking at the manual toothbrush 10 from either side, as best seen in FIG. 1. Also shown in FIG. 2, top end 18 is a curved top end that forms a generally downward u-shaped curve and bottom end 20 is a curved bottom end that forms a generally upward u-shaped curve. As stated above, the cut out 38 may also be referred to as a recess. It is to be understood that the terms cutout 38 or recess may be used interchangeably herein with respect to the tongue scraper section of the manual toothbrush 10. Further, it is to be understood that the cutout 38 or recess may be formed in the manual toothbrush 10 by cutting (e.g., material removal), molding, press stamping, or any other process and be within the intended scope of such a formation in the manual toothbrush 10. In an embodiment, the recess can be considered to be an elongate recess or cut out.

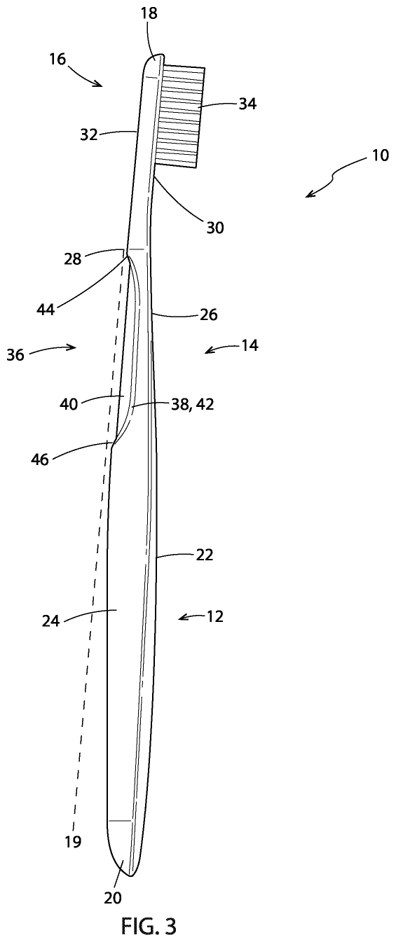

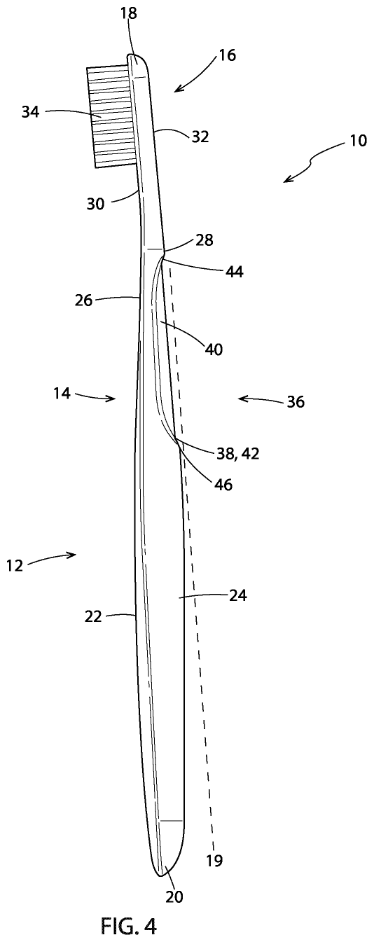

FIG. 3 and FIG. 4 depict a first side 66 and a second side 68, respectively, of the toothbrush 10. There is a first point 44 on the neck region 14 and a second point 46 on the rear surface 28 of neck region 14. The first point 44 and the second point 46 define where the tongue scraper 36, which may include the cut out 38 and the scraping edge 40, begins and ends. First point 44 is adjacent to the head 16 of the manual toothbrush while second point 46 is adjacent to the handle 12 of the manual toothbrush 10. The first point 44 and second point 46 are the beginning of the concave exterior surface 42 of the cut out 38. In an embodiment, the first point 44 and second point 46 extend outwardly further than the scraping edge 40 to allow the toothbrush 10 to rest on a surface on the rear side of toothbrush 10 without the scraping edge 40 coming into contact with the surface that the toothbrush 10 is resting on. That is, in the embodiment, the scraping edge 40 lies entirely within a length of the concave exterior surface 42 and below at least one of the rear surface 32 of the brush head 16 and the rear surface 24 of the handle 12.

First point 44 and second point 46 further act as transition points. Head 16 extends from the top end 18 to the first transition point 44. First point 44 is the transition point from the head 16 of the toothbrush 10 to the neck region 14 of the toothbrush which extends from first point 44 to second point 46. Second point 46 is the transition point from the neck region of the toothbrush 10 to the handle 12 which extends from the transition point 46 to bottom end 20.

FIG. 3 and FIG. 4 further depict an embodiment defining a first plane 19 wherein the scraping edge 40 of tongue scraper 36 remains inside of the first plane 19. The first plane 19 extends from the end of the head 16 to the bottom end 20 of the manual toothbrush 10 along the rear surface 28 of the neck region 14 and along the rear surface 24 of the handle 12. The first plane 19 depicts that the tongue scraper 36 does not touch a flat surface when the toothbrush is resting on a flat surface on its back. In other words, per the embodiment, the scraping edge 40 is between plane 19 and the front surface 26 of the neck region 14, residing fully within the concave exterior surface 42.

FIG. 5 depicts the rear side of the manual toothbrush 10. Dimension 48 represents the distance from top end 18 to the top end 50 of scraping edge 40. In one exemplary embodiment the dimension 48 may be within the range of around 41 mm to around 61 mm. In another exemplary embodiment the dimension may be around 51.2 mm. Dimension 52 represents the distance from top end 50 of scraping edge 40 to the bottom end 54 of scraping edge 40. In other words, dimension 52 represents the length of scraping edge 40. In one exemplary embodiment dimension 52 may be within the range of about 25 mm to 45 mm. In another exemplary embodiment dimension 52 may be about 35.2 mm. Dimension 48 further represents what portion of the toothbrush 10 is the head 16. The distance between the head 16 and the top end 50 of the scraping edge 40 is marginal (e.g., 1-4 mm) but is significant because the slight separation of the head 16 and the tongue scraper 36 allows for a person to brush their teeth without the tongue scraper 36 hindering the effectiveness of the bristles 34 by coming into contact with the user's cheeks, gums, or other parts of the mouth.

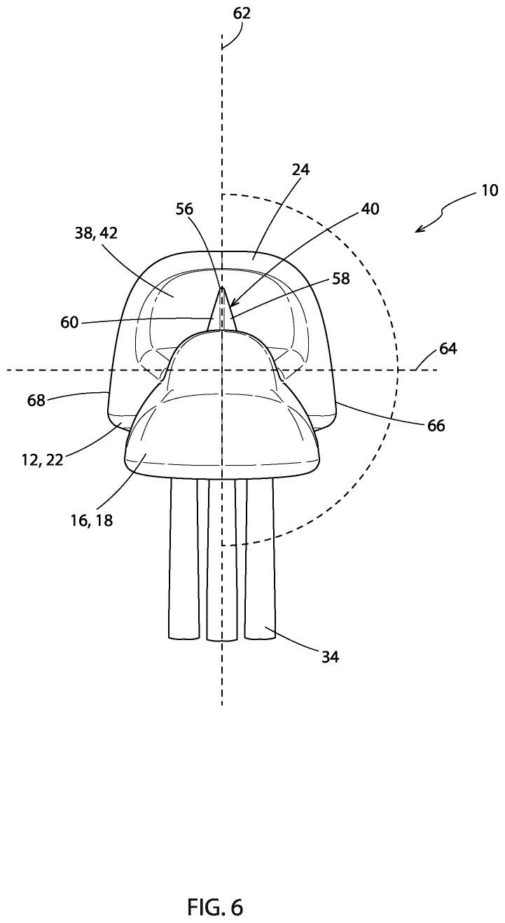

FIG. 6 depicts scraping edge 40 having a point 56 (e.g. edge point 56), a first tapered or angled side wall 58, and a second tapered or angled side wall 60. First side wall 58 and second side wall 60 come together to form point 56. Scraping edge 40 has the shape of a generally elongated pyramid and is integrally connected to exterior surface 42 of cut out 38. In one exemplary embodiment the angle of the point 56 may be within a range of about 30 degrees to 50 degrees. In another exemplary embodiment the angle of point 56 may be around 40 degrees.

FIG. 6 depicts a longitudinal plane 62, wherein the longitudinal plane 62 extends the length of toothbrush 10 from the front surface to the rear surface and a latitudinal plane 64 wherein the latitudinal plane 64 extends the width of the toothbrush from the first side 66 to the second side 68. Plane 62 is orthogonal to plane 64. When the toothbrush is oriented in the manner shown in FIG. 6, the scraping edge 40 is above plane 64 while bristles 34 are below plane 64. Point 56 of scraping edge 40 lies along plane 62, and walls 58 and 60 extend away from the plane 62 from point 56. First side 66 and second side 68 of the toothbrush 10 are on opposing sides of plane 62.

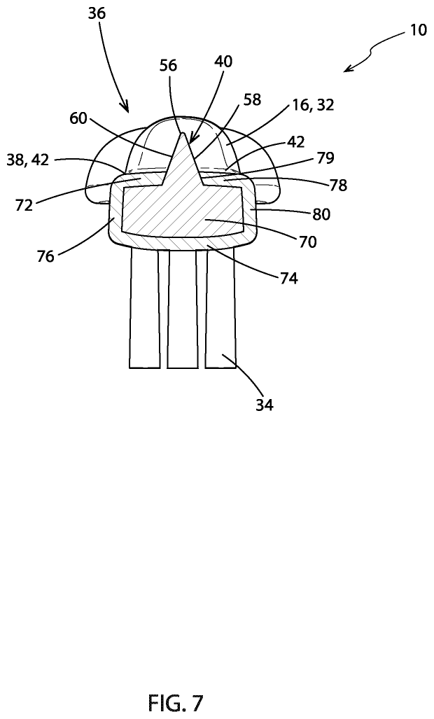

FIG. 7 depicts the materials from which the tongue scraper 36 is fabricated or made from. As shown in FIG. 7, the scraping edge 40 may be made from plastic or a hard rubber material. In an embodiment, the exterior surface 42 of cut out 38 may be made from TPU rubber or another type of rubber. The scraping edge 40 being a single scraping edge that is made from plastic or a hard rubber material can allow for the strongest edge force for scraping the tongue.

FIG. 7 further shows the configuration of the cut out 38 having most of the tongue scraper disposed inside of the cut out 38 with just the scraping edge 40 protruding from the exterior surface 42 of the cut out 38. The exterior surface 42 extends outwardly from both sides 58 and 60 of scraping edge 40. Exterior surface 42 is a generally C-shaped exterior surface wherein there is a body portion 70 of the scraping edge 40 inside the space or cavity defined by surface 42 on the body of the toothbrush 10. The exterior surface 42 has a first top wall 72 and a bottom wall 74 wherein the first top wall 72 and the bottom wall 74 are connected by a first side wall 76. Bottom wall 74 is a generally straight bottom wall with a very slight curve to follow the slight curve in the neck region 14. Exterior surface 42 may also include a second top wall 78 wherein the bottom wall 74 is connected to the second top wall 78 by a second side wall 80. The body portion 70 is marginally smaller than the exterior surface 42 and the body portion 70 rests completely inside of the exterior surface 42 except for the scraping edge 40 where the scraping edge 40 extends outwardly between the first top wall 72 and the second top wall 78. The body 70 is a generally rectangular shape wherein the body 70 fits within the spaces defined by the exterior surface 42 by the first top wall 72, bottom wall 74, first side wall 76, second top wall 78, and second side wall 80. There is a space 79 that is defined by the opening between the first top wall 72 and the second top wall 78 wherein the scraping edge 40 may fill the gap to extend upwardly from the body 70.

A second embodiment of the manual toothbrush 110 may include a handle 112, a neck region 114, and a brush head 116. The manual toothbrush 110 may further include a top end 118 and a bottom end 120, wherein the top end 118 is opposed to the bottom end 120. The direction of top and bottom may change during operation and may then be located in a top, bottom, first side, or second side of the manual toothbrush 110. In an embodiment, the top end 118 may be considered to be associated with a distal end of the brush head 116, and the bottom end 120 may be associated with a distal end of the handle 112.

FIG. 8 depicts the second embodiment of manual toothbrush 110. FIG. 8 shows that the handle 112 has a front surface 122 and a rear surface 124 wherein the front surface 122 and rear surface 124 are opposite sides of the manual toothbrush 110. The neck region 114 has a front surface 126 and a rear surface 128 wherein the front surface 126 and the rear surface 128 are opposite sides of the manual toothbrush. Front surface 126 of the neck region 114 may be coextensive or continuous with the front surface 122 of the handle 112. Rear surface 128 of the neck region 114 may be coextensive or continuous with the rear surface 124 of the handle 112. The head 116 of the toothbrush 110 has a front surface 130 and a rear surface 132 wherein the front surface 130 and the rear surface 132 are opposite sides of the manual toothbrush 110. On the front surface 130 of head 116 there are bristles 134 that extend outwardly therefrom to respective terminal ends and away from the rear surface 132 of brush head 116.

Handle 112, neck region 114, and brush head 116 collectively define manual toothbrush 110, per the second embodiment. The handle 112 is the lower portion of the manual toothbrush 110 that may be used to grip the toothbrush 110 by the user. The neck region 114 of the toothbrush is the space between the handle 112 of the toothbrush 110 and the head 116 of the toothbrush 110. The head 116 is at the top of the neck region 114, and the head 116 contains the bristles 134 which are used to clean the end user's teeth.

FIG. 8 further depicts handle 112 having a tongue scraper 136. In the depicted embodiment, there is a cut out or recess 138 formed on the handle region 112. In one embodiment, the cut out 138 extends throughout a portion of the handle 112. However, it is possible for the cut out 138 to extend the entirety of the handle 112. Inside the cut out 138, there is a scraping edge 140 mounted or formed therein. In one embodiment the scraping edge 140 may be made from plastic or a hard rubber material. In an embodiment, the cut out 138 is deep enough to allow the scraping edge 140 to be flush inside of the cut out 138 to prevent the scraping edge 140 from touching a surface if the toothbrush 110 was laid flat on the rear side of the toothbrush. Cut out 138 has a concave exterior surface 142 wherein the scraping edge 140 contacts or is connected to the exterior surface 142. In one exemplary embodiment, the exterior surface 142 of the cut out 138 may be made of TPU rubber or another material—similar to the handle 112 of the manual toothbrush 110. The cut out 138 forms an elongated u-shape or a concave wall when looking at the manual toothbrush 110 from either side, as best seen in FIG. 8. Also shown in FIG. 8, top end 118 is a curved top end that forms a generally downward u-shaped curve and bottom end 120 is a curved bottom end that forms a generally upward u-shaped curve.

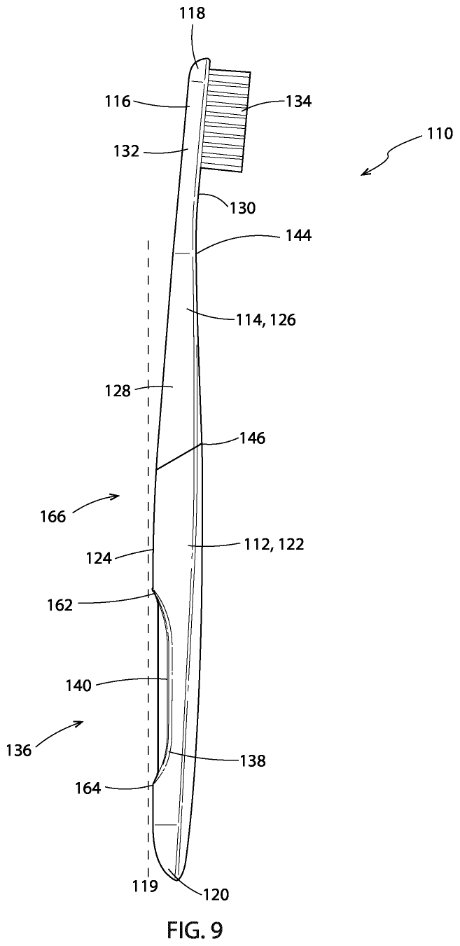

FIG. 8 further depicts a first side 166, as shown in FIG. 9, and a second side 168, where there is a first point 144 on the neck region 114 and a second point 146 on the neck region. The first point 144 and the second point 146 define the neck region 114. First point 144 is adjacent to the head 116 of the manual toothbrush while second point 146 is adjacent to the handle 112 of the manual toothbrush 110. First point 144 and second point 146 further act as transition points. Head 116 extends from the top end 118 to the first transition point 144. First point 144 is the transition point from the head 116 of the toothbrush 110 to the neck region 114 of the toothbrush which extends from first point 144 to second point 146. Second point 146 is the transition point from the neck region 114 of the toothbrush 110 to the handle 112 which extends from the transition point 146 to bottom end 120 (i.e., a distal end of the handle 112).

FIG. 9 shows the first side 166 of manual toothbrush 110. A first contact point 162 and a second contact point 164 are shown. The first contact point 162 is located at the top end of the cut out 138 where the second contact point 164 is located at the bottom end of the cut out 138. The first contact point 162 and the second contact point 164 may rest on a flat surface to prevent the scraping edge 140 from touching the surface. The first contact point 162 and the second contact point 164 represent the length of the cut out 138.

FIG. 9 further depicts a first plane 119 wherein the scraping edge 140 of tongue scraper 136 remains inside of the first plane 119. The first plane 119 extends from the bottom of the head 116 to the bottom end 120 of the toothbrush 110 along the rear surface 128 of the neck region 114 and along the rear surface 124 of the handle 112. The first plane 119 depicts that the tongue scraper 136 does not touch a flat surface when the toothbrush is resting on a flat surface on its back. In other words, the plane 119 shows that the scraping edge 140 may stay within the limits of plane 119 and the front surface 122 of the handle 112. Likewise, the scraping edge 140 may stay within the limits of the rear surface 124 and the front surface 122 of the handle 112.

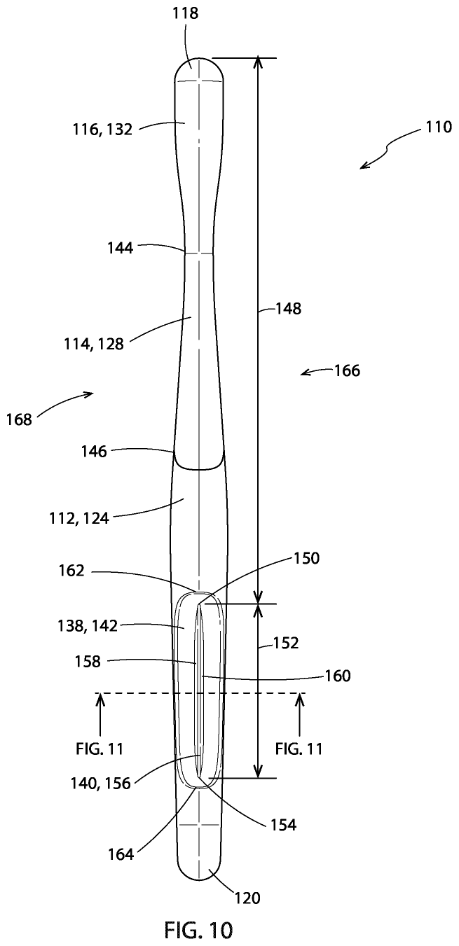

FIG. 10 depicts the rear side of the manual toothbrush 110. Dimension 148 represents the distance from top end 118 to the top end 150 of scraping edge 140. Dimension 152 represents the distance from top end 150 of scraping edge 140 to the bottom end 154 of scraping edge 140. In other words, dimension 152 represents the length of scraping edge 140. In one exemplary embodiment, dimension 152 may be within the range of about 25 mm to 45 mm. In another exemplary embodiment dimension 52 may be about 35.2 mm. Dimension 148 further incorporates the length of head 116 and neck region 114 combined, along with a portion of handle 112. In one exemplary embodiment the dimension 148 may be within the range of around 41 mm to around 61 mm. In another exemplary embodiment the dimension 148 may be around 51.2 mm. The distance between the head 116 and the top end 150 of the scraping edge 140 is greater than that of the first embodiment which may allow for a person to rotate the toothbrush 110 to use the tongue scraper 136 as it is located on the rear side 124 of handle 112.

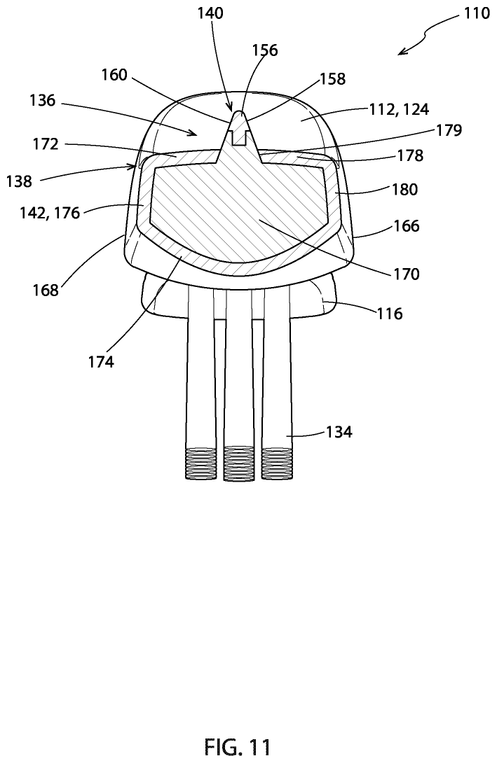

FIG. 11 depicts, in part, scraping edge 140 having a point 156, a first tapered or angled side wall 158, and a second tapered or angled side wall 160. First side wall 158 and second side wall 160 have a contact point (e.g., together forming an apex) that defines point 156. In an embodiment, such as that shown, the point 156 may be slightly rounded to increase user comfort during scraping and/or during handle holding during brushing. In an embodiment, scraping edge 140 has the shape of a generally elongated pyramid and is integrally connected to or co-molded with the exterior surface 142 of cut out or recess 138. In one exemplary embodiment, the angle of the point 156 may be within a range of about 30 degrees to 50 degrees. In another exemplary embodiment, the angle of point 156 may be around 40 degrees.

FIG. 11 depicts the materials from which the tongue scraper 136 is fabricated or made from. Per the embodiment shown in FIG. 11, the scraping edge 140 may be made from plastic, while the point 156 may be made from TPU rubber. The exterior surface 142 of cut out 138 may be made from TPU rubber. The scraping edge 140 can be a single scraping edge that is made from plastic. Meanwhile, having a TPU rubber point 156 allows for a softer edge force with an increased friction on the tongue as can be provided by having TPU rubber on the point 156.

FIG. 11 further shows the configuration of the cut out 138 having most of the tongue scraper 136 disposed inside of the cut out 138 with just the scraping edge 140 protruding from the exterior surface 142 of the cut out 138. Exterior surface 142 is a generally C-shaped exterior surface with a body portion 170 of the scraping edge 140 being positioned and received inside the space or cavity defined by surface 142 on the body of the toothbrush and thereby received within the cutout 138. The exterior surface 142 has a first top wall 172 and a bottom wall 174, wherein the first top wall 172 and the bottom wall 174 are connected by a first side wall 176. Bottom wall 174 is a generally curved bottom wall 174 to follow the curve of the handle 12. Exterior surface 142 may also include a second top wall 178, wherein the bottom wall 174 is connected to the second top wall 178 by a second side wall 180. The body portion 170 is marginally smaller than the exterior surface 142, and the body portion 170 rests completely inside of the exterior surface 142 except for the scraping edge 140. The scraping edge 140 extends outwardly between the first top wall 172 and the second top wall 178. In this exemplary embodiment the body portion 170 is larger than other embodiments shown because of the location of the tongue scraper 136 being on the handle 112. There is a space 179 that is defined by the opening between the first top wall 172 and the second top wall 178 wherein the scraping edge 140 may fill the gap to extend upwardly from the body 170. In an embodiment, the scraping edge 140 may extend diametrically opposite the bristles 134.

A third embodiment of the manual toothbrush 210 may include a handle 212, a neck region 214, and a brush head 216. The manual toothbrush 210 may further include a top end 218 and a bottom end 220, wherein the top end 218 is opposed to the bottom end 220. The direction of top and bottom may change during operation and may then be located in a top, bottom, first side, or second side of the manual toothbrush 210. In an embodiment, the top end 218 may be considered to be associated with a proximal end of the brush head 216 of the manual toothbrush 210, and the bottom end 220 may be considered to be associated with a distal end of the handle 212 thereof.

FIG. 12 depicts the handle 212 having a front surface 222 and a rear surface 224 wherein the front surface 222 and the rear surface 224 are integrally connected but opposite each other. The handle 212 may be made from TPU rubber, plastic, or any other similar material. For example, the material may be a sufficiently hard polymeric material deemed suitable for use as a toothbrush material. FIG. 12 further depicts the neck region 214 as having a front surface 226 and a rear surface 228. As per the embodiment shown in FIG. 12, brush head 216 has a front surface 230 opposite a rear surface 232. Front surface 226 of the neck region 214 may be coextensive or continuous with the front surface 222 of the handle 212. Rear surface 228 of the neck region 214 may be coextensive or continuous with the rear surface 224 of the handle 212. Front surface 230 of brush head 216 includes bristles 234, wherein the bristles are fixedly connected to the front surface 230 of the brush head 216 and extend outward therefrom to respective terminal ends and away from the rear surface 232 of brush head 216.

Handle 212, neck region 214, and brush head 216 collectively define manual toothbrush 210. The handle 212 is the lower portion of the manual toothbrush 210 that may be used to grip the toothbrush 210 by the user. The neck region 214 of the toothbrush is the space between the handle 212 of the toothbrush 210 and the head 216 of the toothbrush 210. The head 216 is at the top of the neck region 214, and the head 216 contains the bristles 234 which are used to clean the end user's teeth.

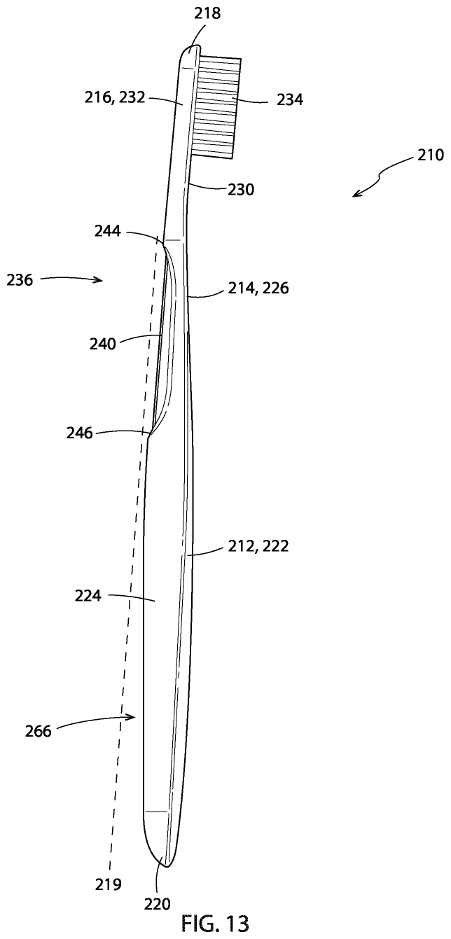

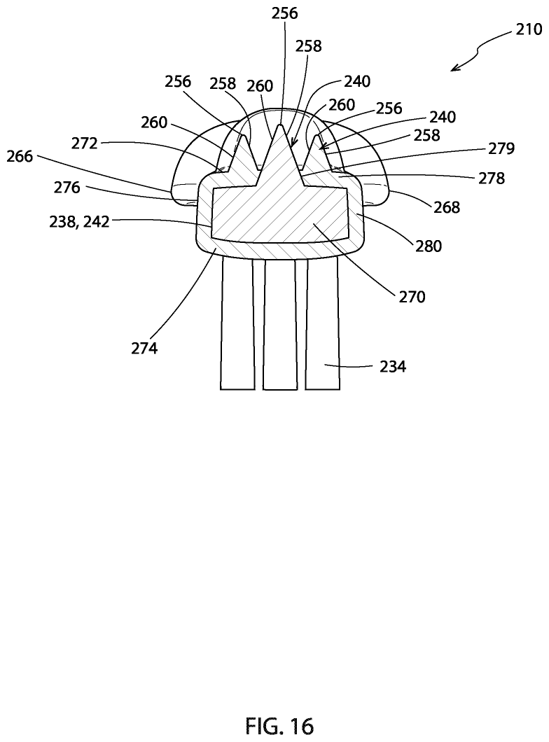

Focusing on the neck region 214, a tongue scraper 236 is shown. In the depicted embodiment, there is a cut out or recess 238 defined in the neck region 214. In one embodiment, the cut out 238 extends the length of the neck region 214. However, it is possible for cut out 238 to extend only a portion of the length of the neck region 214. Inside the cut out 238, there is a plurality of scraping edges 240. In one embodiment, the scraping edges 240 may be made of plastic, TPU rubber, or a combination, where at least one scraping edge is made of TPU rubber and at least one scraping edge is made of plastic, as best seen in FIG. 16. In the shown embodiment, two scraping edges 240 (e.g., the outer two) may be made from TPU rubber, and one scraping edge 240 (e.g., the center one) may be made from plastic. The cut out 238 is deep enough to allow the scraping edges 240 to be flush inside of the cut out 238 to prevent the scraping edges 240 from touching a surface if the toothbrush 210 was to be laid flat on the rear side of the toothbrush. Cut out 238 has an exterior surface 242 wherein the scraping edges 240 are, for example, co-molded with or integrally connected to the exterior surface 242. In one exemplary embodiment, the exterior surface 242 of the cut out 238 may be made of TPU rubber or another similar material—similar to the handle 212 of the manual toothbrush 210. For example, the material can be a sufficiently hard polymeric material conducive for use as part of a toothbrush body. The cut out 238 forms an elongated u-shape or a concave wall when looking at the manual toothbrush 210 from either side, as best seen in FIG. 13. Also shown in FIG. 12, top end 218 is a curved top end that forms a generally downward u-shaped curve, and bottom end 220 is a curved bottom end that forms a generally upward u-shaped curve.

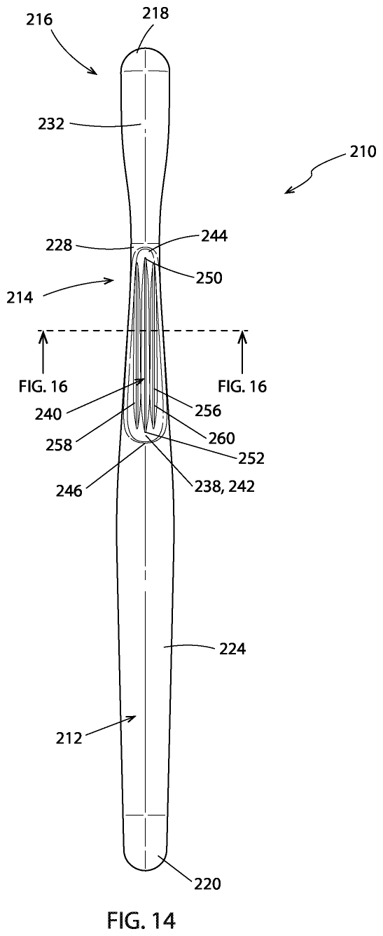

FIG. 13 depicts a first side 266, where there is a second side 268 which can be seen in FIG. 14. There is a first point or position 244 on the neck region 214 and a second point or position 246 on the neck region. The first point 244 and the second point 246 define where the tongue scraper 236, which includes the cut out 238 and the scraping edge 240, begins and ends. First point 244 is adjacent to the head 216 of the manual toothbrush 210 while second point 246 is adjacent to the handle 212 of the manual toothbrush 210. The first point 244 and second point 246 act as the beginning of the concave exterior surface 242 of the cut out or recess 238. The first point 244 and second point 246 extend outwardly further than the scraping edges 240 to allow the toothbrush 210 to rest on a surface on the rear side of toothbrush 210 without the scraping edges 240 coming into contact with the surface that the toothbrush 210 is resting on. First point 244 and second point 246 further are transition points. Head 216 extends from the top end 218 to the first transition point 244. First point 244 is the transition point from the head 216 of the toothbrush 210 to the neck region 214 of the toothbrush, which extends from first point 244 to second point 246. Second point 246 is the transition point from the neck region of the toothbrush 210 to the handle 212, which extends from the second point 246 to bottom end 220.

FIG. 13 further depicts a first plane 219 wherein the scraping edges 240 of tongue scraper 236 remain inside of (i.e., below) the first plane 219. The first plane 219 coextends with and away from the rear surface 232 of the head 216. The first plane 219 extends from the bottom of the head 216 to the bottom end 220 of the toothbrush 210 along the rear surface 228 of the neck region 214 and along the rear surface 224 of the handle 212. The first plane 219 depicts that the tongue scraper 236 does not touch a flat surface when the toothbrush 210 is resting on a flat surface on its back. In other words, the plane 219 shows that the scraping edges 240 may stay within the limits of the plane 219 and the front surface 226 of the neck region 214.

FIG. 14 depicts the rear side of the manual toothbrush 210. The distance between top end 218 and first transition point 244 is the length of the head 216. The distance from the first transition point 244 to second transition point 246 is or is essentially so the length of the neck region. The distance between the second transition point 244 and bottom end 220 is the length of the handle 212. The lengths of the scraping edges 240 are measured from the top end of the scraping edge 250 to the bottom end of the scraping edge 252. The distance between the head 216 and the top end 250 of the scraping edges 240 is marginal, but that marginal difference can be considered to be significant because the slight separation of the head 216 and the tongue scraper 236 allows for a person to brush their teeth without the tongue scraper 236 hindering the effectiveness of the bristles 234.

FIG. 14 further depicts scraping edges 240 having points 256 (e.g., edge points 256), first tapered or angled side walls 258, and second tapered or angled side walls 260. First side walls 258 and second side walls 260 come together to form points 256. It is to be understood that there may be a plurality of points 256, first side walls 258, and second side walls 260 but that only one of each interacts with the other portions to form a singular scraping edge 240. That is, a respective first side wall 258 and second side wall 260 pairing together form a corresponding scraping edge 240. There may be multiple scraping edges 240, which is the reason for multiple points 256, first side walls 258 and second side walls 260. Scraping edges 240 each have the shape of a generally elongated pyramid and are integrally connected to or co-molded with exterior surface 242 of cut out 238. In one exemplary embodiment, the angle of the points 256 may be within a range of about 30 degrees to 50 degrees. In another exemplary embodiment, the angle of points 256 may be around 40 degrees.

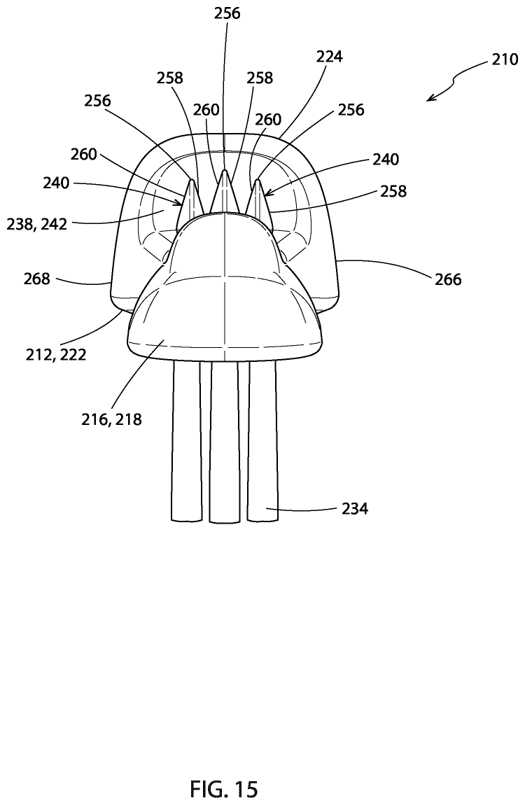

FIG. 15 depicts that scraping edges 240 are recessed inside of the neck portion 214 of the manual toothbrush 210. FIG. 15 further depicts that the scraping edges 240 may be various heights and, in some instances, may have different angles for each scraping edge to provide for different levels of force that could be provided by the scraping edges 240 of tongue scraper 236.

FIG. 16 depicts the materials that the tongue scraper 236 may be made from. As shown in FIG. 16, the scraping edges 240 may be made from plastic and/or TPU rubber, wherein one scraping edge may be made from plastic and two may be made from TPU rubber or where one scraping edge may be made of TPU rubber and two may be made of plastic, or any combination thereof. The exterior surface 242 of cut out 238 may be made from TPU rubber. The scraping edges 240 include multiple scraping edges. In one embodiment, one such scraping edge 240 can be plastic and two such scraping edges can be formed of TPU rubber. The use of multiple scraping edges 240 may be more efficient while having a lower edge force. In the shown embodiment, there are three scraping edges 240 wherein the outside scraping edges 240 are made from TPU rubber, and the middle scraping edge 240 is made from plastic.

FIG. 16 further shows the configuration of the cut out 238 having the tongue scraper 236 disposed inside of the cut out 238, with just the scraping edges 240 protruding from the exterior surface 242 of the cut out 238 while maintaining the scraping edges inside the recess that cut out 238 creates. Exterior surface 242 is a generally C-shaped exterior surface, wherein there is a body portion 270 of the scraping edge 240 inside the space or cavity defined by surface 242 on the body of the toothbrush 210. The exterior surface 242 has a first top wall 272 and a bottom wall 274, wherein the first top wall 272 and the bottom wall 274 are connected by a first side wall 276. Bottom wall 274 is a generally straight bottom wall with a very slight curve to follow the slight curve in the neck region 214. Exterior surface 242 may also include a second top wall 278, wherein the bottom wall 274 is connected to the second top wall 278 by a second side wall 280. The body portion 270 is marginally smaller than the exterior surface 242, and the body portion 270 thereby rests completely inside of the exterior surface 242 except for one scraping edge 240. The one scraping edge 240 not resting completely inside thereof extends outwardly between the first top wall 272 and the second top wall 278. First top wall 272 has an additional scraping edge 240 extending outwardly from the exterior surface 242, and second top wall 278 has a third scraping edge 240 extending outwardly from the exterior surface 242. There is a space 279 that is defined by the opening between the first top wall 272 and the second top wall 278 wherein the scraping edge 240 may fill the gap to extend upwardly from the body 270.

A fourth embodiment of the manual toothbrush 310 may include a handle 312, a neck region 314, and a brush head 316. The manual toothbrush 310 may further include a top end 318 and a bottom end 320, wherein the top end 318 is opposed to the bottom end 320. The direction of top and bottom may change during operation and may then be located in a top, bottom, first side, or second side of the manual toothbrush 310. In an embodiment, the top end 318 can be associated with a proximal end of the brush head 316, and the bottom end 320 can be associated with a distal end of the handle 312.

FIG. 17 depicts the handle 312 having a front surface 322 and a rear surface 324, wherein the front surface 322 and the rear surface 324 are integrally connected but opposite each other. The handle 312 may be made from TPU rubber, plastic, or any other material suitable for toothbrush manufacture. For example, the material may be a suitable hard polymeric material suitable for oral use. FIG. 17 further depicts the neck region 314 as having a front surface 326 and a rear surface 328. As shown in FIG. 17 brush head 316 has a front surface 330 opposite a rear surface 332. Front surface 326 of the neck region 314 may be coextensive or continuous with the front surface 322 of the handle 312. Rear surface 328 of the neck region 314 may be coextensive or continuous with the rear surface 324 of the handle 312. Front surface 330 of brush head 316 includes bristles 334, wherein the bristles 334 are fixedly connected to the front surface 330 of the brush head 316 and extend outward therefrom to respective terminal ends and are directed diametrically away from the rear surface 332 of brush head 316.

Handle 312, neck region 314, and brush head 316 collectively define manual toothbrush 310. The handle 312 is the lower portion of the manual toothbrush 310 that may be used to grip the toothbrush 310 by the user. The neck region 314 of the toothbrush is the space between the handle 312 of the toothbrush 310 and the head 316 of the toothbrush 310. The head 316 is at the top of the neck region 314, and the head 316 contains/carries the bristles 334, which are used to clean the end user's teeth.

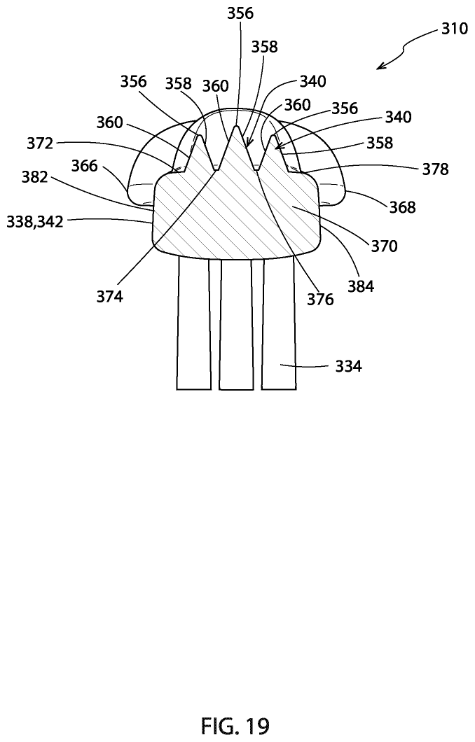

Focusing on the neck region 314, a tongue scraper 336 is shown. In the depicted embodiment, there is a cut out or recess 338 defined in the neck region 314. In one embodiment, the cut out 338 extends the length of the neck region 314. However, it is possible for the cut out 338 to extend only a portion of the length of the neck region 314. Inside the cut out 338, there is a plurality of scraping edges 340. In one embodiment, the scraping edges 340 may be made from plastic, as best seen in FIG. 19. The cut out 338 can be deep enough to allow the scraping edges 340 to be flush inside of the cut out 338 to prevent the scraping edges 340 from touching a surface if the toothbrush 310 was to be laid flat on the rear side of the toothbrush. Cut out 338 has an exterior surface 342, wherein the scraping edges 340 contact or are connected to the exterior surface 342. In one exemplary embodiment, the exterior surface 342 of the cut out 338 may be made of TPU rubber or other material similar to the handle 312 of the manual toothbrush 310 (e.g., a similarly hard polymeric material suitable for oral use). The cut out 338 forms an elongated u-shape or a concave wall when looking at the manual toothbrush 310 from either side, as best seen in FIG. 17. Also shown in FIG. 17, top end 318 is a curved top end that forms a generally downward u-shaped curve and bottom end 320 is a curved bottom end that forms a generally upward u-shaped curve.

FIG. 17 further depicts a first plane 319 wherein the scraping edges 340 of tongue scraper 336 remain inside of the first plane 319. The first plane 319 extends from the head 316 to the bottom end 320 of the toothbrush 310 along the rear surface 328 of the neck region 314 and along the rear surface 324 of the handle 312. In particular, the first plane 319 can coextend with the rear surface 332 of brush head 316, projecting away therefrom toward the bottom end 320 of the toothbrush 310. The first plane 319 depicts that the tongue scraper 336 does not touch a flat surface when the toothbrush is resting on a flat surface on its back. In other words, the plane 319 shows that the scraping edges 340 may stay within the limits of the plane 319 and the front surface 326 of the neck region 314.

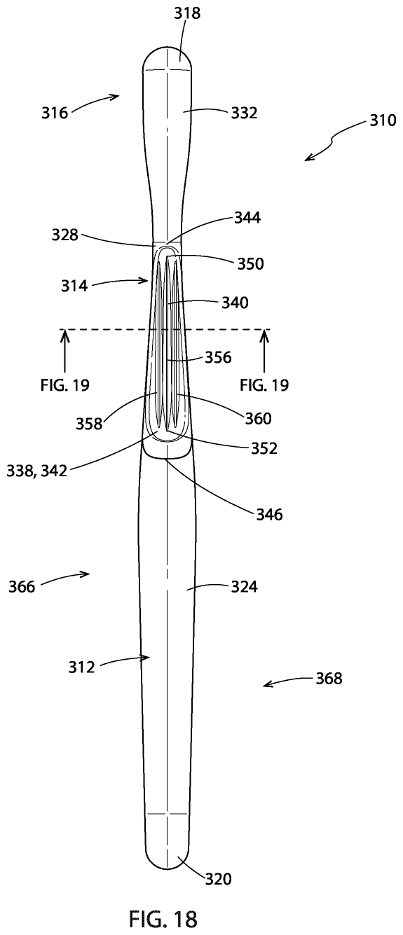

FIG. 18 depicts the rear side of the manual toothbrush 310. The distance between the top end 318 and first transition point 344 is the length of the head 316. In an embodiment, the distance from the first transition point 344 to second transition point 346 is the length of the neck region. In an embodiment, the distance between the second transition point 344 and bottom end 320 is the length of the handle 312. The lengths of the scraping edges 340 are measured from the top end of the scraping edges 350 to the bottom end of the scraping edges 352. The distance between the head 316 and the top end 350 of the scraping edges 340 is marginal. However, that marginal separation distance is significant because the slight separation of the head 316 and the tongue scraper 336 allows for a person to brush their teeth without the tongue scraper 336 hindering the effectiveness of the bristles 334.

FIG. 18 further depicts scraping edges 340 having points 356, first tapered side walls 358, and second tapered side walls 360. Respective pairs of first tapered side walls 358 and second tapered side walls 360 come together to form corresponding points 356 (e.g., edge points 356). It is to be understood that there may be a plurality of points 356, first tapered side walls 358, and second tapered side walls 360, but only one respective set of each (e.g., a respective point 356, a respective first tapered side wall 358, and a respective second tapered side wall 360) interacts to form a singular scraping edge 340. There may be multiple scraping edges 340, which is the reason for multiple points 356, first tapered side walls 358 and second tapered side walls 360.

Scraping edges 340 each have the shape of a generally elongated pyramid and are integrally connected to exterior surface 342 of cut out 338. FIG. 18 further shows that there is a first side 366 and a second side 368 that are opposite sides of the manual toothbrush 310 and wherein the first side 366 and the second side 368 are mirror images of one another. In one exemplary embodiment the angle of the points 356 may be within a range of about 30 degrees to 50 degrees. In another exemplary embodiment the angle of points 356 may be around 40 degrees.

FIG. 19 depicts the materials that the tongue scraper 336 may be made from. As shown in FIG. 19, the scraping edges 340 may be made from plastic, wherein the plurality of scraping edges are made from the same material which may create a higher edge force. The exterior surface 342 of cut out 338 may be made from plastic. In the shown embodiment, there are three scraping edges 340 wherein the three scraping edges 240 are all made from plastic. The exterior surface 342 and the three scraping edges 240 can be co-molded or otherwise integrally formed of a plastic or other similarly hard polymeric material suitable for oral use. There may, however, be any number of scraping edges present in tongue scraper 336.

FIG. 19 further shows the configuration of the cut out 338 having the tongue scraper 336 integrally molded inside of the cut out 338 with just the scraping edges 340 protruding from the exterior surface 342 of the cut out 338, while maintaining the scraping edges inside the recess that cut out 338 creates. There may be a body portion 370 of the scraping edge 340 wherein the body portion 370 is generally rectangular. The exterior surface 342 of body portion 370 has a first top wall 372, a second top wall 374 where there is a scraping edge 340 between the first top wall 372 and the second top wall 374. There may be a third top wall 376, wherein there is a scraping edge 340 between the second top wall 374 and the third top wall 376. There may be a fourth top wall 378, where there is a scraping edge 240 between the third top wall 376 and the fourth top wall 378. First top wall 372 is connected to a bottom wall 380 by a first side wall 382. Fourth top wall 378 is connected to the bottom wall 380 by a second side wall 384 to form a generally rectangular body portion 370.

FIG. 20 depicts the consumer 400 using any one of the aforementioned embodiments of the manual toothbrush 10, 110, 210, or 310. In FIG. 20, the end user may be using manual toothbrush 10, 210, or 310 for tongue scraping, with the position adjusted due to the respective location of the tongue scraper 36, 236, 336. It is to be understood that the method of using manual toothbrush 10, 210, or 310 are the same and for clarity purposes, only the method of using manual toothbrush 10 will be discussed. A brief discussion of the method of use for manual toothbrush 110 will also be included herein.

FIG. 20 depicts the consumer 400 using manual toothbrush 10. Consumer 400 is holding the handle 12 with their hand 402, while turning the toothbrush 10 to be perpendicular to the consumer's 400 tongue 404. The consumer 400 then places the tongue scraper 36, which is located in the neck region 14 of the toothbrush 10 in the illustrated embodiment, on to the top surface of their tongue 404. The head 16 of the toothbrush 10 remains adjacent to the tongue 404 of the consumer 400. The consumer 400 may then continuously move the toothbrush 10, in the horizontal position with the scraping edge 40 in contact with the tongue 404, in a vertical and downward motion repeatedly until the consumer 400 is satisfied with the cleanliness of their tongue 404. Once the consumer 400 is satisfied, the consumer 400 may then remove the scraping edge 40 from the tongue 404 and turn the toothbrush 10 back into a vertical position and will be finished using the tongue scraper 36. The method for using the manual toothbrush 210 and 310 is substantially similar to the description provided for the method of using manual toothbrush 10, adjusted for the relative position of their respective tongue scraper 236, 336.

It is to be understood that the method of using the manual toothbrush 110 is substantially similar to the method of using the manual toothbrush 10 as described above. For the manual toothbrush 110, the consumer 400 would hold the toothbrush 110 at the neck region 114 with their hand 402 and place the scraping edge 140 of tongue scraper 136 on their tongue 404. The head 116 would be outside the grip of the consumer 400 so that the bristles 134 are not damaged by being held by the consumer.

All of the above configurations may be mixed together such as having the tongue scraper location lower on the body with three scraping edges or with one scraping edge. Another exemplary embodiment may have the tongue scraper located on the handle while having all TPU rubber scraping edges. These are a few combinations of the presented embodiments that may be used.

In another exemplary embodiment, the tongue scraper may be located on either side of the toothbrush or facing the front. It is to be understood that if the tongue scraper were located in any other location on the toothbrush that is not shown that the tongue scraper would have the same features as the embodiments that are currently shown. It is to be understood with respect to all of the various embodiments of the manual toothbrush 10, 110, 210, or 310, their respective cutout or recess 38, 138, 238, 338 may be formed in the manual toothbrush 10 by cutting (e.g., material removal), molding, press stamping, or any other process and be within the intended scope of such a formation. That is, the cutout formation need not expressly be cut out of the manual toothbrush 10, 110, 210, or 310 to be considered to be within the scope of a cutout or recess 38, 138, 238, 338. In an embodiment, the cutout or recess 38, 138, 238, 338 may be an elongate recess with its length being its largest dimension, and the elongate recess may further be oriented along the lengthwise direction of the manual toothbrush 10, 110, 210, 310.

The respective edge points 56, 156, 256, 356 of the corresponding scraping edges 40, 140, 240, 340 may be slightly rounded (as typically illustrated) at their respective apexes to promote movement across the user's tongue and promote user comfort and still be within the scope of the intended meaning of the term. In embodiments where a plastic material is to be employed, it is to be understood that any plastic that is sufficiently hard and/or stiff enough for the intended use and deemed safe for oral and/or dental use may be employed and be within the scope of the present disclosure. In embodiments where a TPU rubber can be employed, it is to be understood that any rubber or polymeric material with similar mechanical properties (e.g., hardness, level of pliability) and considered suitable for dental or oral use may be used in place of the TPU rubber and thus considered to be within the scope of the present disclosure.

With respect to the head 16, 116, 216, 316, it is to be understood that the corresponding bristles 34, 134, 234, 334 associated therewith can be considered to be carried thereby (e.g., mounted therein) and extend therefrom. Each of the brush head 16, 116, 216, 316, the neck region 14, 114, 214, 314, and the handle 12, 112, 212, 312 can respectively define a front surface and a rear surface. The rear surface of each can generally face away from the bristles 34, 134, 234, 334 carried by their respective brush head 16, 116, 216, 316. The cutout or recess 38, 138, 238, 338 may be formed in one of the neck region 14, 114, 214, 314 or the handle 12, 112, 212, 312, and, more specifically, in a rear surface thereof, as illustrated in the various Figures. It is to be understood, as seen from the various embodiments, that the scraping edge and/edge point 56, 156, 256, 356 thereof can be integral with or attached to the body portion 70, 170, 270, 370 thereof, and any such arrangement is clearly within the scope of the present disclosure. That is, in any embodiment, the edge point 56, 156, 256, 356 and/or the protruding section of the scraping edge is ultimately carried by the corresponding body portion 70, 170, 270, 370 thereof.

With any of the various embodiments of the manual toothbrush 10, 110, 210, 310, the corresponding handle 12, 112, 212, 312, neck region 14, 114, 214, 314, and brush head 16, 116, 216, 316 can be operatively linked to one another in that general order (e.g., the neck region carrying the handle on its distal end and carrying the brush head on its proximal end). In an embodiment, the corresponding handle 12, 112, 212, 312, neck region 14, 114, 214, 314, and brush head 16, 116, 216, 316 can be integrally or separably coupled to one another, in that order. For example, such components can be co-formed or co-molded as a unitary construction to yield a base portion of a given manual toothbrush 10, 110, 210, 310. In an embodiment, the corresponding handle 12, 112, 212, 312, neck region 14, 114, 214, 314, and brush head 16, 116, 216, 316 can be formed of at least one of a hard rubber material or a plastic material. The hard rubber material may be, for example, TPU rubber or another rubber material with a hardness of at least Shore 60A. Also, in some embodiments, there may not be any express dividing lines between such components (e.g., handle, neck region, and/or brush head), and such variants are still considered to be within the scope of the present disclosure. In such situations where there are no clear lines demarking the transition between such components, the brush head 16, 116, 216, 316 can be considered to be a proximal section carrying the bristles 34, 134, 234, 334; the neck region 14, 114, 214, 314 can be a central/intermediate region transitioning between the brush head and handle; and the handle 12, 112, 212, 312 can be a distal section (carried by the neck region opposite the brush head) configured to be gripped by a user's hand.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the scraping edges being generally triangular they may be, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A manual toothbrush comprising:
a handle including a handle front surface and a handle rear surface, wherein the handle front surface and handle rear surface are opposed to one another and define a thickness of the handle therebetween;
a head defining a head front surface and a head rear surface, wherein the head front surface has a plurality of bristles extending therefrom;
a neck region defining a neck front surface and a neck rear surface, the neck region being located between the handle and the head of the toothbrush, wherein one of the neck region or the handle can define a recess therein; and
a tongue scraper carried in the recess defined in the one of the neck region or the handle, the tongue scraper including at least one scraping edge that extends within the recess and projects away from the recess;
wherein a thickness dimension of the scraping edge is less than a thickness of the toothbrush;
wherein a first plane co-extends from the head rear surface of the toothbrush towards an end of the handle; and
wherein a depth dimension of each scraping edge is chosen so that the at least one scraping edge extends below the first plane, the tongue scraper thereby configured to not touch an adjoining flat surface when the toothbrush is resting on a back surface of the toothbrush.

2. The manual toothbrush of claim 1, wherein the at least one scraping edge is comprised of at least one of a plastic material or a hard rubber material.

3. The manual toothbrush of claim 2, wherein the at least one scraping edge is comprised of plastic and wherein a point of the scraping edge is made from a rubber material.

4. The manual toothbrush of claim 1, wherein the recess for carrying the tongue scraper is located in the rear surface of the neck region.

5. The manual toothbrush of claim 1, wherein the recess for carrying the tongue scraper is located in the rear surface of the handle.

6. The manual toothbrush of claim 1, further comprising a plurality of scraping edges, wherein at least one of the scraping edges is made from plastic.

7. The manual toothbrush of claim 1, wherein the at least one scraping edge has a rounded point.

8. The manual toothbrush of claim 1, wherein the at least one scraping edge lies entirely within the recess.

9. The manual toothbrush of claim 1, wherein at least a portion of the recess defines a recess exterior surface, wherein the at least one scraping edge at least one of contacts or is connected to the recess exterior surface.

10. The manual toothbrush of claim 1, wherein the recess exterior surface is comprised of a rubber material.

11. The manual toothbrush of claim 1, wherein the recess exterior surface is at least one of carried by or integral with the one of the neck region and the handle in which the recess is formed.

12. The manual toothbrush of claim 1, wherein the handle, the neck region, and the brush head are each comprised of at least one of a hard rubber material or a plastic material.

13. The manual toothbrush of claim 1, wherein the handle, the neck region, and the brush head are operatively coupled to one another, in that order.

14. A manual toothbrush, comprising:
a head defining a head front surface and a head rear surface, the head front surface having a plurality of bristles extending therefrom;
a neck region defining a neck front surface and a neck rear surface;
a handle defining a handle front surface and a handle rear surface, the head rear surface, the neck rear surface, and the handle rear surface all generally facing away from the bristles carried by the head;
wherein one of the neck region and the handle defines a recess therein;
wherein the manual toothbrush further includes a tongue scraper, the tongue scraper carried in the recess defined in the one of the neck region or the handle, the tongue scraper including at least one scraping edge extending within the recess;
wherein a first plane co-extends from the head rear surface toothbrush towards an end of the handle; and
wherein the at least one scraping edge extends toward the first plane and remains therebelow, the tongue scraper thereby configured to not touch an adjoining flat surface when the toothbrush is resting on a back surface of the toothbrush.

15. The manual toothbrush of claim 14, wherein the at least one scraping edge is comprised of at least one of a plastic material or a hard rubber material.

16. The manual toothbrush of claim 15, wherein the at least one scraping edge is comprised of plastic and wherein a point of the scraping edge is made from a rubber material.

17. The manual toothbrush of claim 14, wherein the recess for carrying the tongue scraper is located in the neck rear surface.

18. The manual toothbrush of claim 14, wherein the recess for carrying the tongue scraper is located in the handle rear surface.

19. The manual toothbrush of claim 14, further comprising a plurality of scraping edges.

20. The manual toothbrush of claim 14, wherein the at least one scraping edge lies entirely within the recess.
